(19) United States
(12) Patent Application Publication
(10) Pub. No.: US 2008/0174804 A1
(43) Pub. Date: Jul. 24, 2008

(54) Method and System for Transmitting Print Information Between A Client and A Server Over A Wide Area Network

(76) Inventors: Raymond Hsu, San Jose, CA (US); Takashi Shiozaki, Saratoga, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/625,183

(22) Filed: Jan. 19, 2007

(51) Int. Cl. G06K 1/00

(52) U.S. Cl. 358/1.15

(57) ABSTRACT

The present invention is directed to a method and system of transmitting print information from a client computer to one of a plurality of print fulfillment centers over a wide area network that features selecting one of the plurality of print fulfillment centers based upon print attributes. To that end, the method includes generating a print request that produces a visual display, on the client computer, of a printer driver interface to communicate with a printer driver in furtherance of producing a transcription of print data. Print attributes are entered into a printer driver, as well as billing and shipment information. A print transaction file is generated with the printer driver. The print transaction file includes the print data, print attributes and the billing and shipment information. The print transaction file is transmitted to one or more of the plurality of print fulfillment centers over a wide area network. Also disclosed is a system that carries-out of the functions of the method.

### BACKGROUND OF THE INVENTION

The present invention is directed to a computer system and more particularly to printing over networks.

Data networks, such as the “Internet”, typically include a plurality of users implementing client computers communicating with remote server computers to transfer information therebetween. To facilitate the transfer, the users employ a computer system having a “web” browser that provides graphical user interface (GUI)-based communication with a “web page” obtained from a server. One popular collection of servers uses a standardized Hypertext Transfer Protocol (HTTP) to provide information and is known as the “World Wide Web”. The information is presented as web pages written as text with standardized formatting and control symbols known as HyperText Mark-up Language (HTML). HTML provides basic document formatting and allows a server to specify “links” to other servers and files.

Use of an HTML-compliant browser involves specification of a link via a Uniform Resource Locator (URL). Upon such specification, the user's client computer makes a TCP/IP request to the server identified in the link and receives an HTML file that is interpreted by the browser so that an electronic HTML document made up of one or more web pages may be displayed on the client's computer.

Recently it has been suggested to employ the Internet to facilitate reproduction of data that would traditionally been accomplished using print resources that are located proximate to the situs in which the data to be reproduced is created. The Internet print shop provided by Kinkos® is an exemplary service that facilitates printing with use of the Internet. After generating print data employing standard software applications, a web browser is used to access the Kinkos® website and take advantage of the functionality provided thereby. To that end, registration information is provided vis-à-vis the web browser. The print data is saved as a file and then transmitted employing HTTP (Hypertext Transport Protocol) transporting the same over the Internet to Kinkos®. After receiving the file, Kinkos® processes it using the appropriate application to print out the print job.

Therefore, printing using the Kinkos® system requires the user to activate an application (e.g. a web browser) other than the application in which the file was created in order to submit the print job for printing over the Internet by Kinkos®. Additionally, the print job is submitted to Kinkos® for processing in a format that requires Kinkos® to activate an application program that contains a printer driver specific to a printer within the store, select the file and submit it for printing. Both steps, activating a web browser and activating an application at Kinkos®, require extra processing and make printing over the Internet cumbersome.

U.S. Pat. No. 6,714,964 to Stewart et al., discloses sending data (e.g. print data or a document), in a network environment, to a port monitor, and to upload the data to an upload manager for storing in a database. Relevant data may be sent from a print spooler to the port monitor invoking an upload manager to convey (e.g. securely or non-securely) print data to a web server. A version manager determines whether the printer driver being used to print data is authentic, and data are written to a web server as packets of information and sent to a database for storage. Additionally, a system, method and recordable medium are recognized whereby a pass through (e.g. a port monitor filter) is inserted between a print spooler and a port monitor in order to detach the port monitor from the print spooler such that object code can be upgraded for future versions of software.

U.S. patent publication No. 2002/0078160 to Kemp et al., teaches a method and system to print over the internet using a printer driver, accessible by at least one application program, so as to output print data for transmission over the Internet, by receiving a print request from an application program to print over the Internet, rendering print data to be transmitted over the Internet into a printing definition language, and packaging the rendered print data with a protocol for transmission over the Internet. The printer driver further obtains service provider information, the service provider information representing at least one destination for which the print data can be transmitted to over the Internet. A graphical user interface may provide an interface for obtaining user information and service provider information.

A need exists; therefore, to provide improved print functionality of computer systems using the Internet.

### SUMMARY OF THE INVENTION

The present invention is directed to a method and system of transmitting print information from a client computer to one of a plurality of print fulfillment centers over a wide area network that features selecting one of the plurality of print fulfillment centers based upon print attributes. To that end, the method includes generating a print request that produces a visual display, on the client computer, of a printer driver interface to extend the capabilities thereof while working with software applications that support a print feature to communicate with a printer driver in furtherance of producing a transcription of print data over the Internet. Print attributes are entered into a printer driver, as well as billing and shipment information. A print transaction file is generated with the printer driver. The print transaction file includes the print data, print attributes and the billing and shipment information. The print transaction file is transmitted to one or more of the plurality of print fulfillment centers over a wide area network. Also disclosed is a system that carries-out of the functions of the method. These and other embodiments are described more fully below.

### BRIEF DESCRIPTION OF THE DRAWINGS

The invention, together with further objects and advantages thereof, may best be understood by reference to the following description taken in conjunction with the accompanying drawings in which:

FIG. 1 is an illustration of a system in accordance with one embodiment of the present invention;

FIG. 2 a schematic view of a client computer shown in FIG. 1 in accordance with the present invention;

FIG. 3 is simplified plan view of a printer driver interface PDI that is displayed on a monitor of the client computer;

FIG. 4 is a simplified plan view of a printer driver interface PDI showing an on-line print transaction interface;

FIG. 5 is a flow diagram showing a print sequence in accordance with one embodiment of the present invention;

FIG. 6 is a flow diagram showing a print sequence in accordance with a first alternate embodiment of the present invention;

FIG. 7 is a flow diagram showing a print sequence in accordance with a second alternate embodiment of the present invention; and

FIG. 8 is a flow diagram showing a print sequence in accordance with a third alternate embodiment of the present invention.

### DETAILED DESCRIPTION OF THE INVENTION

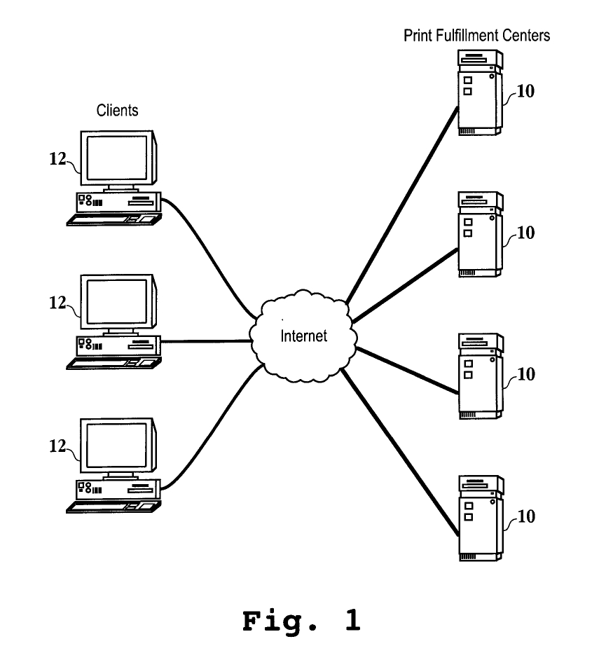

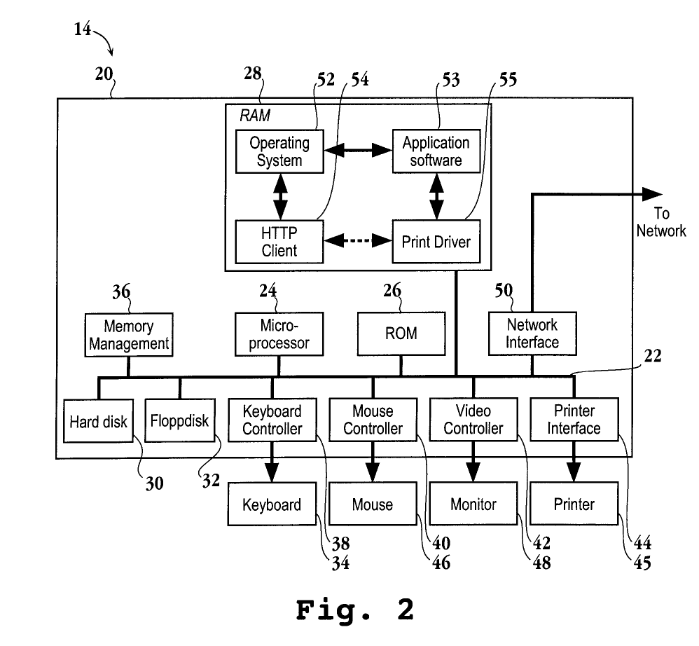

Referring to FIG. 1, a large area network is shown, such as the Internet, which includes a plurality of networked “print fulfillment centers” (PFC) 10 that are accessible by “client terminals” 12. Communication between the PFCs 10 and the client terminals 12 typically occurs over a publicly accessible network, such as a public switched telephone network over ASDL telephone lines or large bandwidth trunks, such as T1 or OC3 service. The client terminals 12 access various PFCs 10 through an Internet service provider, e.g., AOL, COMCAST, EARTHLINK, and the like, by executing application specific software, commonly referred to as a “browser”, on a computer 14, shown more clearly in FIG. 2.

Referring to FIG. 2, the computer 14 includes a system unit 20 having one or more system buses 22 placing various components of the system in data communication. For example, a microprocessor 24 is placed in data communication with both a read only memory (ROM) 26 and random access memory (RAM) 28 via the system bus 22. The ROM 26 contains among other code, the Basic Input-Output system (BIOS) which controls basic hardware operation such as the interaction with peripheral components such as disk drives 30 and 32, as well as the keyboard 34. The RAM 28 is the main memory into which the operating system and application programs are loaded and affords the requisite size memory space. The memory management chip 36 is in data communication with the system bus 22 to control direct memory access (DMA) operations. DMA operations include passing data between the RAM 28 and the hard disk drive 30 and the floppy disk drive 32. Also in data communication with the system bus 22 are various I/O controllers: a keyboard controller 38, a mouse controller 40, a video controller 42, and a printer interface 44. The keyboard controller 38 provides a hardware interface for the keyboard 36, the mouse controller 40 provides the hardware interface for a mouse 46, or other point and click device, and the video controller 42 provides a hardware interface for a monitor 48. Printer interface 44 provides a hardware interface for printer 45. A network interface 50 enables data communication over the network. RAM 28 typically includes an operating system 52 resident therein. The operating system 52 of the computer 14 may be MAC OS®, UNIX®, WINDOWS® XP®, or other known operating system. In the present example, system 52 is WINDOWS® XP®. In data communication with operating system 52 are a number of application specific software, such as a text editor, mail client, database, and the like, shown generally as application software 53. Also in data communication with operating system 52 is an HTTP client 54 that may be selectively placed in data communication with a printer driver 55, indicated by the dashed arrow to facilitate transmission of resources to one or more of PFCs 10.

Referring to both FIGS. 1 and 2, one embodiment of the present invention allows transmission of print data over the Internet employing HTTP client 54 utilizing a TCP/IP connection to pass a print request to one of PFCs 10 running an HTTP “service” (under the WINDOWS operating system) or a “daemon” under the UNIX operating system or other suitable software, depending upon the operating system. In the present example, the request is typically achieved by contacting an HTTP server (not shown) included in a PFC 10 at a suitable universal resource locator (URL) address. In one embodiment of the present invention, the HTTP server (not shown) one of PFCs 10 may respond to the print services request by sending a “web page” formatted as an HTML file. The HTTP client 54 interprets the HTML file and may form a visual representation of the same using local resources, e.g., fonts and colors and a specific implementation of an HTTP client known as a browser (not shown). In an alternate embodiment, PFC 10 may respond by sending an e-mail message. Either of the aforementioned responses by PFC 10 may be confirmatory in nature to ensure that the print request was authenticate, which is discussed more fully below.

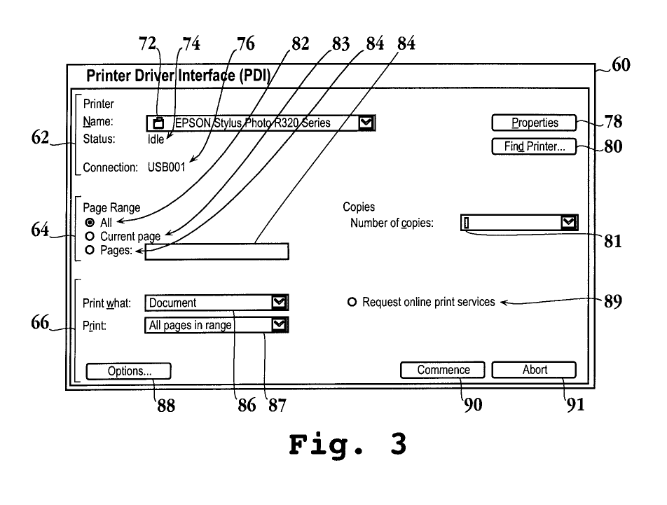

Referring to FIGS. 2 and 3, a print request is generated by printer driver 55. To that end, application software 53 facilitates activation of printer driver 55 by visually displaying a printer driver interface (PDI) 60 on monitor 48. PDI 60 includes multiple regions 62, 64 and 66 that facilitate providing information for a print transaction file employed to transcribe data by a desired printing resource. For example, region 62 includes printer driver selection screen (DSS) 72, which is a pull down menu that may include a list of multiple printer drivers from which to select a desired printer driver and, therefore, the corresponding printer by which to complete print activities. The intended printer model selected in the DSS 72 is included in print attribute information. A status data field (SDF) 74 and a connection data field (CDF) 76 are both included. SDF 74 indicates the operational status of the printer corresponding to the printer driver identified in DSS 72, and CDF 76 identifies the connection of the printer to client 12. Also included in region 62 is a PROPERTIES virtual button 78 that allows the display of an additional screen (not shown) to provide additional print attributes which is a well know in the art, particularly with the WINDOWS® XP® operating system. For example, properties page (not shown) includes print attributes such as Paper Size and Paper Type information that are necessary to produce desired print job. A FIND PRINTER virtual button 80 is included that facilitates searching for a printer that is presently associated with client 12.

Regions 64 and 66 are additional print attribute regions that facilitate generating print information with various attributes corresponding to the resulting visually perceivable document generated. For example, region 64 includes a selection menu 81 that allows selecting a number of transcriptions to occur for the print transaction file (PTF), as well as a plurality of radial buttons 82-84. Radial buttons 82-84 facilitate selecting the number of pages corresponding to print data to be generated. For purposes of the present invention, print data is data that is rendered by the printer driver and is a language that is native to the printer 45, shown in FIG. 2.

Referring again to FIGS. 2 and 3, assigned to radial button 84 is a data entry field 85 that allows selection of specific pages of print data to be transcribed by a print resource. Region 66 includes two pull down menus 86 and 87 and an OPTIONS virtual button 88, which are a well know in the art, particularly with the WINDOWS® XP® operating system. For example, menu 86 facilitates selecting different information included in the print data that may be transcribed independent of the other information included therewith, and menu 87 allows selecting all pages, even pages or odd pages on which the information appears to be transcribed. “OPTIONS” virtual button 88 allows additional print attributes to be included in the PTF (not shown). Also included in region 66 is an on-line services check box 89, a COMMENCE virtual button 90 and an ABORT virtual button 91 that generates the PTF (not shown) or terminates accumulation of information for the PTF, respectively. Upon activating the COMMENCE virtual button 90, PDI 60 closes and print data is generated and sent to the print resources assigned to the printer driver recited in DSS 72 so that transcribing of print data may occur using, in this example, printer 45.

An advantage of the present invention resides in the flexibility provided by PDI 60 were status field 74 to indicate that the print resource assigned to the printer driver recited in DSS 72 was not operational. For example the print resource may be a local printer, such as printer 45 may have a depleted toner supply, may not be multi-chromatic, i.e., be a black-and-white printer, may not have binding, duplexing, stapling or may lack some other feature desired to be part of the transcription of print data included in the PTF. Even when the printer driver recited in DSS 72 was operational, the desired paper type and size may not be presently available on the local printer, or print job may exceed the local supply of the said paper. As a result, the present invention includes a printer driver function to include HTTP transmission of the PTF that includes a print object, print attributes and other information associated with an on-line print transaction occurring vis-à-vis the Internet.

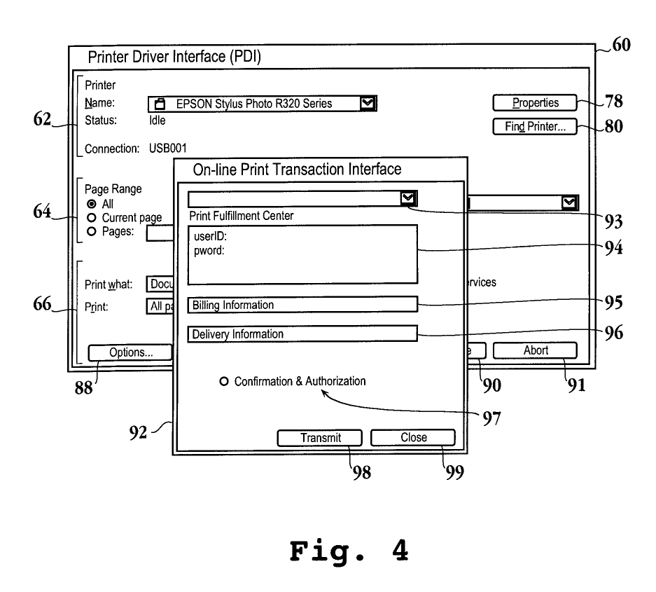

Referring to both FIGS. 3 and 4, were it desired to employ an on-line print resource, printing devices available to complete the print job may be increased from the selections available in DSS 72. After selecting the Request Online Print Service by checking the check box 89 and selecting the COMMENCE virtual button, an on-line print transaction interface (OPI) 92 is displayed on monitor 48. OPI 92 includes a plurality of data entry fields five of which are shown as 93, 94, 95, 96 and 97. Data entry field 93 is optional and allows selecting one of a multiple of on-line print fulfillment centers PFC 10. Data entry field 94 is to receive information concerning user account information that may consist of a userID and a user password. Data entry field 95 is to receive billing information, e.g., payment type, address information and any other information required to secure payment for PFC 10 activities. Data entry field, 96 is to receive delivery information, e.g., the method for transmission of the transcription of the print data. It should be understood that data fields 93, 94, 95, 96 and 97 may be filled automatically from previously saved data or input as new. Data entry field 97 is to receive information corresponding to confirmation requests. For example, if a confirmation is desired, it may be achieved vis-à-vis e-mail and/or launching of particular application software 53 that facilitates communication vis-à-vis HTTP, e.g., a browser. TRANSMIT virtual button 98 sends PTF to the online service provider. CLOSE virtual button 99 terminates the process without sending PTF to the online service provider.

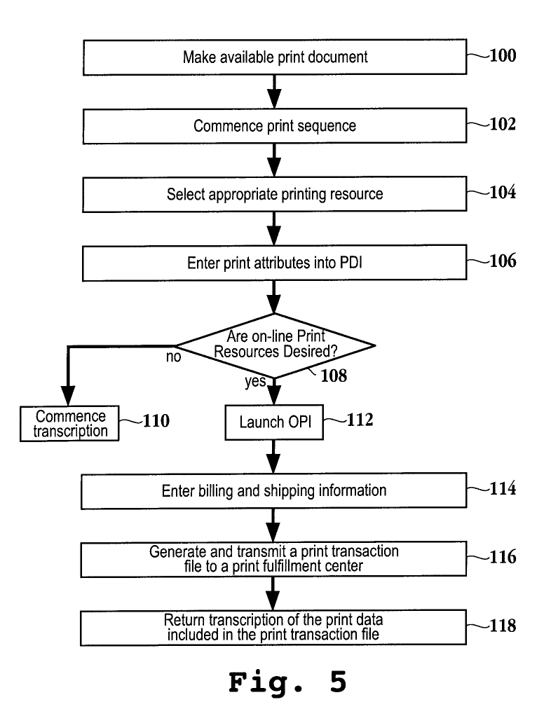

Referring to FIGS. 2, 4 and 5, in operation, at function 100, a print document located on client is available for transcribing to, for example, a fixed tangible copy such as rendered by a conventional printing process. For purposes of the present invention, a print document is data that is native to the application software 53, shown in FIG. 2, that is converted by the printer driver to print data, with the understanding that in some instances the print document data may be the same as print data. An example of a print document includes a JPEG file, a PDF file an MSWord file or some other group of information. At function 102 a print sequence is commenced in which PDI 60 is displayed. The desired print resource would be chosen by selecting the appropriate printer driver name in DSS 72 at function 104. At function 106, the print attributes are entered into PDI 60. At function 108 it is decided whether to employ online print resources. Were this not the case, activation of COMMENCE virtual button 90 would occur and transcription of the print data would occur at function 110.

Were it decided at function 108 to employ online print resource, then check box 89 would be checked and COMMENCE virtual button 90 would be activated. This would launch OPI 92, displaying the same on monitor 48 at function 112. The appropriate information would be included in data entry fields, five of which are shown as 93, 94, 95, 96 and 97 at function 114. After the requisite information was entered into data entry fields, 93, 94, 95, 96 and 97, TRANSMIT virtual button 98 would be activated at which point a print transaction file is generated and subsequently transmitted to a desired PFC 10 at function 116. The print transaction file includes the print attributes and the billing and shipment information, as well as the print object, which includes the data to be printed. At the desired PFC 10 the print transaction file is received and processed accordingly to transcribe the print data associated with the print object in accordance with the print attributes. Thereafter, the transcription of the print data is returned to a desired address in the manner indicated in OPI 92, typically proximate to a situs of the client that submitted the print transaction file at function 118.

Referring to FIGS. 1, 5 and 6, in accordance with another embodiment of the present invention, functions 200, 202, 204, 206, 208, 210, 212, 214, 216 and 218 are the same as functions 100, 102, 104, 106, 108, 100, 112, 114, 116 and 118, respectively. Following function 216, the desired PFC 10 determines whether confirmatory authorization of the billing and shipping information is requested, referred to as a C&A request at function 217. This may be achieved by selecting a check box 97.

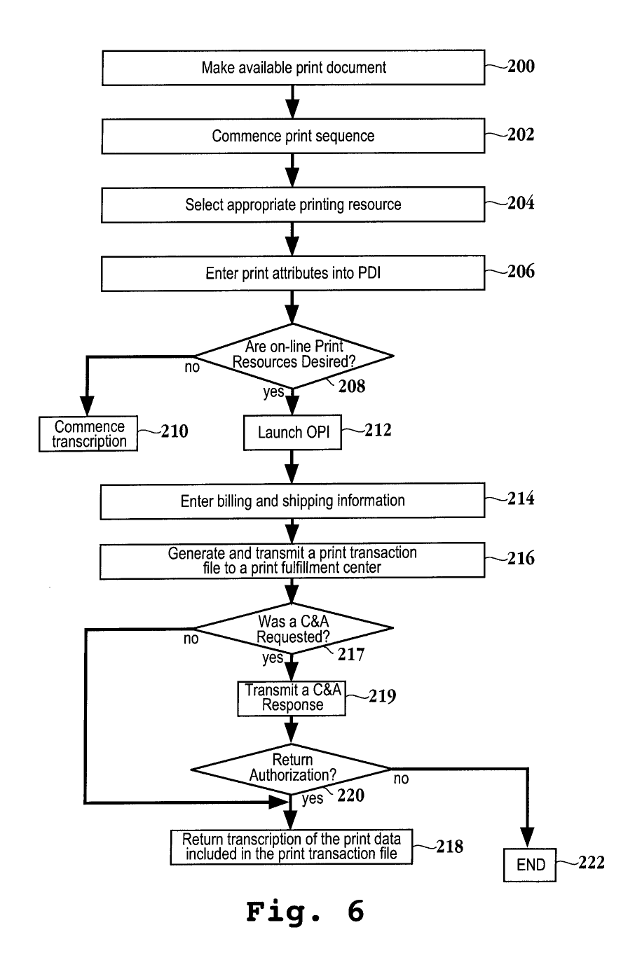

Referring again to FIGS. 1 and 6, were C&A not requested, function 218 occurs. Were a C&A request determined to be present at function 217, the desired PFC 10 would submit a C&A response to the requesting client 12 at function 219. The C&A response includes the billing and shipping information, as well as any other information that is desired and associated with either the print transaction file and/or the requesting client 12 in the manner indicated. For example, the C&A response may include a cost estimate and an estimated time of transcription completion, as well as an estimated time of delivery of the transcription. Additionally a total due for all previously submitted print transaction files may be included. The C&A response may be transmitted via any known method, including e-mail or by launching a browser upon the requesting client 12. At function 220, the requesting client 12 determines whether to authorize the transcription of the print data in the print transaction file. If so, then the request client may return an authorization signal using any known technique, e.g., e-mail, regular post, telephone, by entering data in the website to which the browser is in communication and the like at function 218. If not the print sequent ends at function 222.

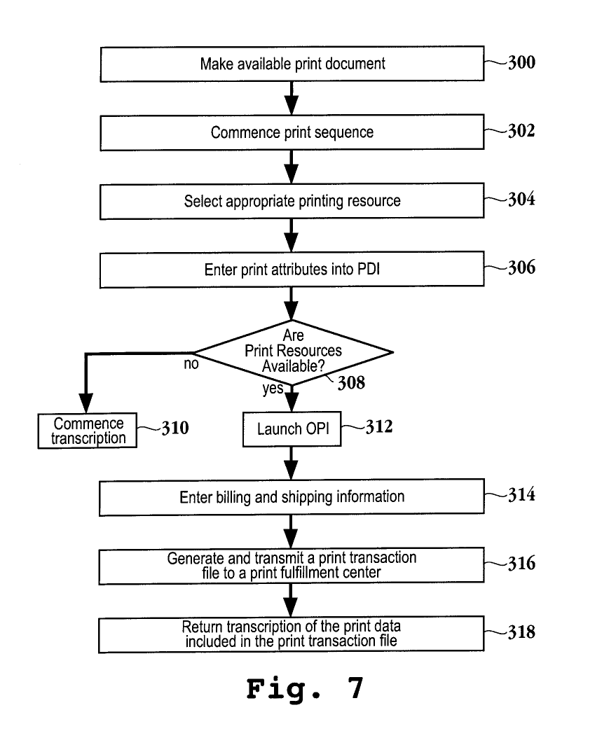

Referring to FIGS. 2, 4, 5 and 7, in another embodiment, OPI 92 need not include data entry field 93, or alternatively data entry field 93 could be employed as an override of a default PFC 10 employed when the print resource identified by the printer driver recited in DSS 72 in incapable of transcribing the print job. Thus an alternate embodiment includes functions 300, 302, 304, 306, 308, 310, 312, 314, 316 and 318 that are the same as functions 100, 102, 104, 106, 100, 112, 114, 116, and 118, respectively. Following function 306, it is determined whether the print resources associated with the printer driver in DSS 72 are available at function 308. At function 308 multiple determinations are undertaken. For example, the information in Status field 74 is analyzed by processor 24 to determine whether the print resource if operational. For example, one of attributes may include photographic quality. Upon activation of COMMENCE virtual button 90, micro-processor 24 would parse and analyze the information in print request. Were it determined that the print resource assigned to the printer driver recited in DSS 72 could not satisfy one or more of the print attributes included in the print request, then OPI 92 would be displayed at function 312 and functions 312, 314, 316 and 318 would occur as discussed above with respect to functions 112, 114, 116 and 118. Specifically, the print attributes provided at function 306 are compared with the functionalities of the printing resource identified at function 304 to determine whether the same may be undertaken. Other examples that may result in launching of OPI 92 are a include duplexing print attribute here the print resource assigned to the printer driver recited in DSS 72 incapable of duplexing and print data on a garment, such as a shirt, or a cup or the print resource simply being out of paper. Typically, client 12 would be dedicated to communicating with only a singly PFC 10 or would automatically communicate with one or more of multiple PFCs 10, dependent upon the print attributes established by data entered in PDI 60. In this manner, the transcription of print data would be seamless with the operation of application software 53 on the requesting client 12

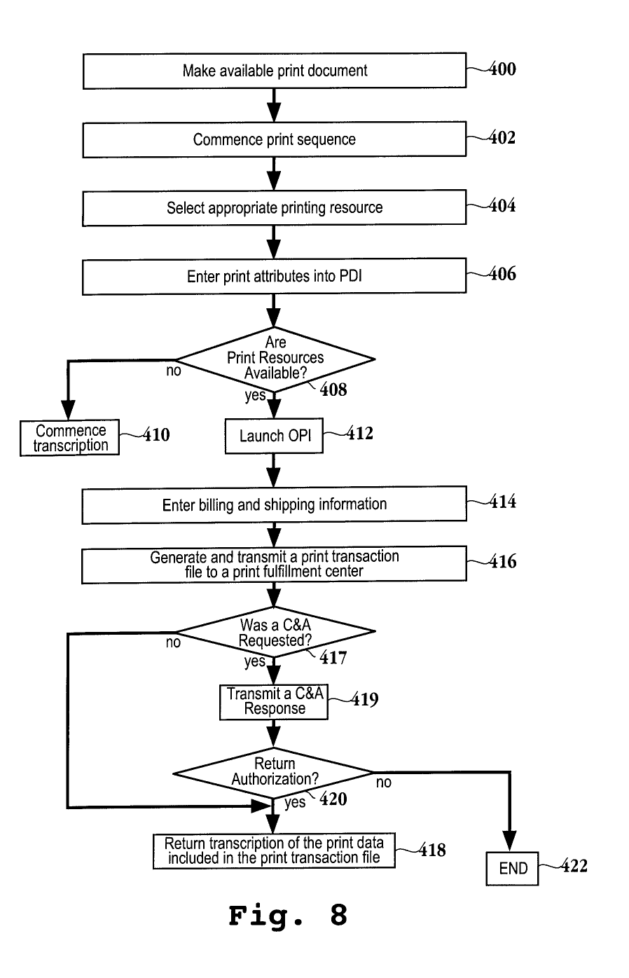

Referring to FIGS. 4, 6, 7 and 8, the automatic launching of OPI 92 could occur in which a C&A is requested by a client. To that end, functions 400, 402, 404, 406, 408, 410, 412, 414, 416, and 418 are identical to functions 300, 302, 304, 306, 308, 310, 312, 314, 316, and 318. Following function 416, functions 417 occurs, which is identical to function 217 in which it is determined by a PFC 10 whether a C&A was requested and if so, functions 419, 420 and 422 are undertaken, which are identical to functions 219, 220 and 222. Otherwise, function 418 is undertaken.

The foregoing description is exemplary and it should be understood that many variations and modification to the above-described invention are contemplated herein. For example, the print transaction file and C&A response may be encrypted. The functions described above with respect to the various embodiments of the invention can also be embodied as computer readable code on a computer readable medium in addition to be in memory of client 14. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion. The scope of the invention should, therefore, be limited with reference to the above description, but instead should be determined with reference to the appended claims along with their full scope of equivalents.

What is claimed is:

1. A method of transmitting print information from a client computer to one of a plurality of print fulfillment centers over a wide area network, the method comprising:
generating a print request that produces a visual display, on said client computer, of a printer driver interface to communicate with a printer driver in furtherance of producing a transcription of print data;
entering print attributes into said printer driver;
providing billing and shipment information in said printer driver;
generating a print transaction file including said print data, print attributes and said billing and shipment information with said printer driver; and
transmitting said print transaction file, with said printer driver, to one of said plurality of print fulfillment centers over a wide area network, with said one of said plurality of print fulfillment centers being selected based upon said print attributes.

2. The method as recited in claim 1 further including encrypting said print transaction file before transmitting said print transaction file.

3. The method as recited in claim 1 further including receiving a confirmation request, at said client computer, from said one of said plurality of print fulfillment centers, to authorize forming a transcription of said print data.

4. The method as recited in claim 1 further including receiving a confirmation request, independent of said printer driver at said client computer, from said one of said plurality of print fulfillment centers, to authorize forming a transcription of said print data corresponding to said print attributes.

5. The method as recited in claim 1 further including receiving a confirmation request, at said client computer, from said one of said plurality of print fulfillment centers, to authorize forming a transcription of said print data corresponding to said print attributes, with said confirmation request being received vis-à-vis an e-mail transmission.

6. The method as recited in claim 1 further including a resource status menu indicating operational capability of a printing resource, and displaying an on-line printing resources interface in response to said operational capability of said local printer being in a predetermined state.

7. The method as recited in claim 1 wherein transmitting further includes transmitting said print transaction file employing an HTTP protocol.

8. The method as recited in claim 1 further including forming, at said one of said plurality of fulfillment centers, a transcription of said print data corresponding to said print attributes and posting said transcription to a situs in which said print driver is located.

9. The method as recited in claim 1 further including forming, at said one of said plurality of fulfillment centers, a transcription corresponding to said print attributes and posting said visually perceivable display to a situs in which said client is located.

10. A method of transmitting print information from a client computer to one of a plurality of print fulfillment centers over a wide area network, the method comprising:
generating a print request that produces a visual display, on said client computer, of a printer driver interface to communicate with a printer driver in furtherance of producing a transcription of print data;
entering print attributes into said printer driver;
providing billing and shipment information in said printer driver;
generating a print transaction file including said print attributes and said billing and shipment information with said printer driver;
transmitting said print transaction file, with said printer driver, to one of said plurality of print fulfillment centers over a wide area network using an HTTP protocol, with said one of said plurality of print fulfillment centers being selected based upon said print attributes; and
forming, at said one of said plurality of fulfillment centers, said transcription of said print data corresponding to said print attributes and posting said transcription to a situs in which said client is located.

11. The method as recited in claim 10 further including encrypting said print transaction file before transmitting said print transaction file.

12. The method as recited in claim 10 further including receiving a confirmation request, at said client computer, from said one of said plurality of print fulfillment centers, to authorize forming said transcription of said print data corresponding to said print attributes.

13. The method as recited in claim 10 further including receiving a confirmation request, independent of said printer driver at said client computer, from said one of said plurality of print fulfillment centers, to authorize forming said transcription.

14. The method as recited in claim 10 further including receiving a confirmation request, at said client computer, from said one of said plurality of print fulfillment centers, to authorize forming said transcription, with said confirmation request being received vis-à-vis an e-mail transmission.

15. The method as recited in claim 10 further including a resource status menu indicating operational capability of a printing resource, and displaying an on-line print resources interface in response to said operational capability of said printing resource being in a predetermined state.

16. The method as recited in claim 10 further including forming, at said one of said plurality of fulfillment centers, said transcription corresponding to said print attributes and posting said transcription to a client specified situs.

17. A client computer system for transmitting print information to one of a plurality of print fulfillment centers over a wide area network, the system comprising:
a processor;
a memory storing a computer program to be operated on by said processor, said computer program including a first sub-routine to enter print attributes into a printer driver, a second sub-routine to provide billing and shipment information to said printer driver, a third sub-routine to produce an attribute file describing print attributes corresponding to a transcription of print data, a fourth sub-routine to produce print order transaction information including user account information for ordering said visually perceivable display, a fifth sub-routine to generate a print transaction file including said print attributes and said billing and shipment information with said printer driver; and a sixth sub-routine to transmit said print transaction file, with said printer driver, to one of said plurality of print fulfillment centers over a wide area network employing an HTTP protocol, with said one of said plurality of print fulfillment centers being selected based upon said print attributes.

18. The system as recited in claim 17 wherein said computer program further includes an additional sub-routine to encrypt said print transaction file before said sixth sub-routine is operated on by said processor to transmit said print transaction file.

19. The method as recited in claim 17 wherein said computer program further includes an additional sub-routine to receive a confirmation request from said one of said plurality of print fulfillment centers to authorize forming said transcription.

20. The system as recited in claim 17 wherein said computer program further includes an additional sub-routine to indicate operational capability of a local printer and generate an on-line print resources interface in response to said operational capability of said local printer being in a predetermined state.
